(19) United States
(12) Patent Application Publication
(10) Pub. No.: US 2020/0301648 A1
(43) Pub. Date: Sep. 24, 2020

(54) METHOD OF OPERATING A SHARED OBJECT IN A VIDEO CALL

(71) Applicant: SHANGHAI ZHANGMEN SCIENCE AND TECHNOLOGY CO., LTD., SHANGHAI (CN)

(72) Inventors: Fanpan SHI, SHANGHAI (CN); Xiaojie MA, SHANGHAI (CN); Shushan XIAO, SHANGHAI (CN); Sinan LI, SHANGHAI (CN); Yin XIA, SHANGHAI (CN)

(21) Appl. No.: 16/886,710

(22) Filed: May 28, 2020

Related U.S. Application Data
(63) Continuation of application No. PCT/CN2018/117991, filed on Nov. 28, 2018.

(30) Foreign Application Priority Data
Nov. 28, 2017 (CN) 201711215782.0

(51) Int. Cl. G06F 3/14; H04N 7/14; H04N 5/445; H04N 5/45; A63F 13/58; A63F 13/87

(52) U.S. Cl. CPC G06F 3/1454; H04N 7/147; A63F 13/87; H04N 5/45; A63F 13/58; H04N 5/44591

(57) ABSTRACT

The present application provides a method of operating a shared object in a video call. The method comprises: establishing, by a first terminal, the video call with a second terminal, and displaying the shared object and a video of an opposite terminal; receiving an operation on the shared object by a user of the first terminal; and presenting, in synchronization with the second terminal, a processing result of the shared object according to the operation. The method described in the present application enables a user of a video session to operate a shared object while being in the video call and an operation result can be displayed synchronously, thus improving collaboration efficiency.

### CROSS REFERENCE TO THE RELATED APPLICATION

This application is the continuation application of International Application No. PCT/CN2018/117991, filed on Nov. 28, 2018, which is based upon and claims priority to Chinese Patent Application No. 201711215782.0, filed on Nov. 28, 2017, the entire contents of which are incorporated herein by reference.

### FIELD

The present application relates to a field of internet application, and particularly relates to a method of operating a shared object in a video call.

### BACKGROUND

Nowadays, network instant messaging tools, i.e., instant messaging software, have been developing to become software tools indispensable for users, and get widely used in leisure and entertainment and work of users. The instant messaging software may provide text, voice, and video sessions to users in the session, and users located in different locations can communicate remotely, which brings great convenience to communications between the users.

However, compared to direct face-to-face communication, remote communication provided by existing instant messaging software is still quiet inconvenient. Therefore, providing an improved solution of remote communication to improve convenience of remote communication is needed.

### SUMMARY

Various aspects of the present application provide a method of operating a shared object in a video call, which enables a user of a video session to operate the shared object while being in the video call.

In an aspect of the present application, a method of operating a shared object in a video call is provided. The method comprises: establishing, by a first terminal, the video call with a second terminal, and displaying the shared object and a video of an opposite terminal; receiving an operation on the shared object by a user of the first terminal; and presenting or storing, in synchronization with the second terminal, a processing result of the shared object according to the operation.

In another aspect of the present application, a method of operating a shared object in a video call is provided. The method comprises: receiving an operation on the shared object by a user of a first terminal that is sent by the first terminal which has established a video call with a second terminal, and the first terminal and the second terminal simultaneously display the shared object and a video of an opposite terminal; processing the shared object according to the operation; and simultaneously sending a processing result to the first terminal and the second terminal, and the first terminal and the second terminal synchronously present or store the processing result of the shared object obtained according to the operation.

In another aspect of the present application, a method of operating a shared object in a video call is provided. The method comprises: establishing, by a second terminal, the video call with a first terminal, and displaying the shared object and a video of an opposite terminal; and presenting or storing a processing result of the shared object obtained according to an operation on the shared object by a user of the first terminal.

In another aspect of the present application, a device is provided. The device comprises: one or more processors; storage means for storing one or more programs. The one or more programs, when executed by the one or more processors, cause the one or more processors to implement any one of the methods described above.

In another aspect of the present application, a computer readable storage medium storing computer programs thereon is provided. The computer programs, when executed by a processor, implement any one of the methods described above.

Some embodiments of the present application enable a user of a video session to operate a shared object while being in the video call and an operation result can be displayed synchronously, thus improving collaboration efficiency and convenience of remote communication.

### DESCRIPTIONS OF THE DRAWINGS

In embodiments of the present application more clearly, drawings required to be used in the descriptions of embodiments or in the prior art will be briefly introduced below. The drawings described below are some embodiments of the present application.

FIG. 1 is a schematic diagram of a process implemented at a first terminal provided in Embodiment One of the present application;

FIG. 2 is a schematic diagram of a process implemented at a network device provided in Embodiment One of the present application;

FIG. 3 is a schematic diagram of a process implemented at a second terminal provided in Embodiment One of the present application;

FIG. 4 is a schematic diagram of a process implemented at a first terminal provided in Embodiment Two of the present application;

FIG. 5 is a schematic diagram of a process implemented at a second terminal provided in Embodiment Two of the present application;

FIG. 6 is a block diagram of an exemplary computer system/server suitable for use in implementing some embodiments of the present disclosure.

### EMBODIMENTS

In addition, the term “and/or” herein only refers to an association relationship which describes associated objects, and represents that there may be three relationships. For example, A and/or B may represent three situations: A exists alone, A and B exist at the same time, or B exists alone. In addition, the character “/” herein generally represents that the preceding and the latter of the associated objects are in an “or” relationship.

It should be understood that although the terms first, second, etc. may be employed to describe terminals in the embodiments of the present disclosure, these keywords are not limited to these terms, and these terms are merely used to distinguish the terminals from each other. For example, without departing from the scope of the embodiments of the present disclosure, a first terminal may also be referred as a second terminal, and similarly, a second terminal may also be referred as a first terminal.

The core concept of the present disclosure comprises: operating, by a user of a video session, a shared object presented on a terminal together with a video of an opposite terminal while being in a video call with the terminal, and a processing result being presented or stored synchronously, in which:

a first terminal establishes the video call with a second terminal, and displays the shared object and the video of the opposite terminal; receives an operation on the shared object by a local user; and presents or stores, in synchronization with the second terminal, the processing result of the shared object according to the operation. The video of the opposite terminal represents a video recorded by another terminal which is running a call with the terminal. For example, the video of the opposite terminal for the first terminal is a video recorded by the second terminal which is running a video call with the first terminal, and the video of the opposite terminal for the second terminal is a video recorded by the first terminal which is running a video call with the second terminal.

A second terminal establishes a video call with a first terminal, and displays a shared object and a video of an opposite terminal; and presents or stores a processing result of the shared object obtained according to an operation on the shared object by a user of the first terminal.

In one embodiment, the processing result comprises change of the shared object determined according to the operation on the shared object by the user. In some embodiments, the change may comprise a result of the change of the shared object. In some embodiments, the change may comprise a process of the change of the shared object.

Determining the processing result of the shared object according to the operation may be implemented in a manner that includes and is not be limited to the following ways: determining, by a network device, the processing result of the shared object based on the operation on the shared object by a user which is provided by a terminal, and determining, by the terminal, the processing result of the shared object based on the operation on the shared object by the user. The aforementioned two ways of determining the processing result will be described in detail below in connection with Embodiment One and Embodiment Two respectively.

### Embodiment One

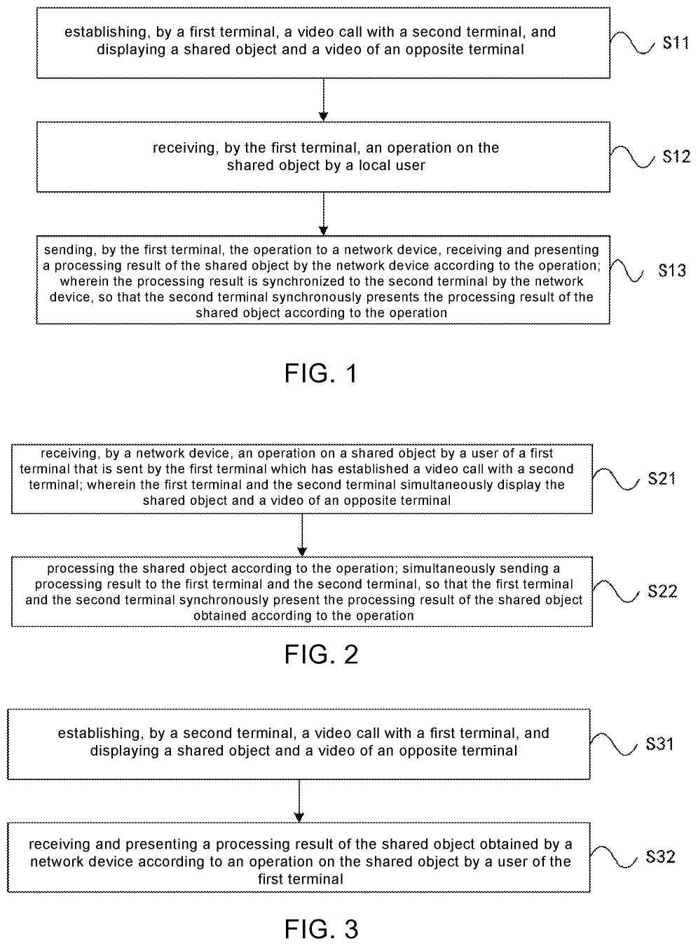

FIG. 1 is a schematic diagram of a process implemented at a first terminal provided in Embodiment One of the present application. As shown in FIG. 1, the process comprises the following steps:

step S11, the first terminal establishes the video call with a second terminal, and displays a shared object and a video of an opposite terminal;

step S12, the first terminal receives an operation on the shared object by a local user; and

step S13, the first terminal sends the operation to a network device, receives, and presents or stores a processing result of the shared object by the network device according to the operation; and the processing result is synchronized to the second terminal by the network device, and the second terminal synchronously presents or stores the processing result of the shared object according to the operation.

The method shown in FIG. 1 may be performed by a first terminal installed with instant messaging software.

The terminal includes but is not limited to any type of smart terminal device for human-machine interaction with users, such as a smart phone, a tablet, a laptop, etc. The smart terminal device may adopt any operating system, such as android operating system, iOS operating system, Windows operating system, etc.

The network device may be a sharing server. The sharing server may be the same server as the instant messaging server, or may be a different server. In the following embodiments of the present disclosure, the network device is described as a separate sharing server as an example, but this is not intended to be limitation. In some embodiments, the network device includes but is not limited to a single server, a server cluster or a cloud server, etc.

It should be noted that the method of operating the shared object in the video call described in some embodiments of the present disclosure is mainly applied in a scenario where a user conducts instant messaging with a mobile terminal. In one embodiment, multiple users who use mobile terminals for instant messaging may be two or more users. The multiple users may make a group video call. Since operations performed by the multiple users are similar, user A on a first terminal and user B on a second terminal are taken as examples for illustration in this embodiment. User A on the first terminal operates the shared object, and the second terminal may synchronously present or store the processing result of the shared object determined based on the operation on the shared object by user A. The above example in this embodiment is merely for illustration, but not for limitation. In some embodiments, the mobile terminal used by each of the multiple users who use the mobile terminals for instant messaging can not only be used by the user to operate the displayed shared object, and display or store a processing result of the shared object, but also synchronously present or store the processing result determined according to the operation on the shared object by another user who is in instant messaging with the user who is using the mobile terminal. In some embodiments, the processing result is presentable, and the first terminal and the second terminal may present the processing result synchronously. In some embodiments, the processing result is hidden (for example, unpresentable), and the first terminal and the second terminal may store the processing result synchronously.

It should be noted that “synchronously” in the present application may not be “simultaneously”. For example, due to influence of factors such as network transmission speed, stability etc., there may be a certain time difference between presenting or storing of a processing result on a first terminal and presenting or storing of the processing result on a second terminal. However, the above situation should still be understood as the processing result being synchronously presented or stored on the first terminal and the second terminal.

In one embodiment of step S11, the first terminal establishes the video call with the second terminal, and displays a shared object and a video of an opposite terminal. The shared object may be determined before, at the same time when, or after the video call is established. In some embodiments, the video of the opposite terminal is displayed in a first display area in a video call interface of the first terminal, and the shared object is displayed in a second display area in the video call interface of the first terminal. Also, the video of the opposite terminal is displayed in a first display area in a video call interface of the second terminal, and the shared object is displayed a second display area in the video call interface of the second terminal.

In one embodiment, user A successfully logs in an instant messaging software client (hereinafter referred to as “an IM client”) on the first terminal, and then establishes an instant session with user B who successfully logs in an IM client on the second terminal through an instant messaging server. User A determines a shared object with user B. For example, user A clicks a menu in a window of the instant session with user B, and further clicks a submenu for sharing objects, and selects a shared object with user B in a pop-up window through a display instruction, for example, an office document. The office document is a network document on a sharing server. After the office document has been displayed in the second display areas of the first terminal and the second terminal, user A may initiate a video call by clicking a video call button on his/her session window.

In one embodiment, user A successfully logs in an IM client on the first terminal, and then establishes an instant session with user B who successfully logs in an IM client on the second terminal through an instant messaging server. User A determines a shared object with user B and initiates a video call. For example, user A clicks a menu in an instant session window, and further clicks a submenu for sharing objects, selects a shared object with user B in a pop-up window through a display instruction, for example, an office document, and simultaneously initiates a video call with user B. The office document is a network document on a sharing server.

In one embodiment, user A successfully logs in an IM client on the first terminal, and then establishes a video session with user B who successfully logs in an IM client on the second terminal through an instant messaging server. User A determines a shared object with user B. For example, user A clicks a menu in a session window, and further clicks a submenu for sharing objects, and selects a shared object with user B in a pop-up window through a display instruction, for example, an office document. The office document is a network document on a sharing server.

In one embodiment, the office document is a document uploaded to the sharing server in advance. Alternatively, the office document is a document selected by user A and then uploaded to the sharing server.

In one embodiment, when a shared object with user B is determined, user A may send a link or identification information of the shared object with user B in a sharing server to user B without the need to send the shared object to user B again. As such, not only data is saved, but also there is no need to coordinate and uniform multiple versions of the shared object with user B. When user B clicks the link of the shared object sent by user A, the shared object will be opened in the second terminal, or user B obtains the shared object from the sharing server according to the identification information of the shared object sent by user A, and opens the shared object in the second terminal. Alternatively, when a shared object with user B is determined, user A may send a request to share the object with user B to the sharing server, and the request is forwarded by the sharing server to user B. When user B accepts the request, the shared object is automatically opened in the second terminal, without requiring any other operation from user B.

The session window is divided into at least two display areas, in which a first display area is a session interface and a second display area is a shared object display interface. The office document is displayed on the shared object display interface.

A video of user B is displayed in a first display area of a session window of user A. Meanwhile, a video of user A is displayed in a first display area in a session window of user B.

In one embodiment, while the video of user B is displayed in the first display area of the session window of user A, a third display area may be set up for displaying a local video of user A. The third display area may be displayed in parallel with the first display area, or may be displayed in a picture in picture mode etc. No specific limitation is made herein.

The office document is displayed in a second display area of a session window of user A. Meanwhile, the office document is displayed in a second display area of a session window of user B. The office documents displayed in the session windows of user A and user B are the same.

In some embodiments, the shared object includes but is not limited to: a document file, an image, a game, and so on. In one embodiment, the display instruction may include, but is not limited to: a file opening instruction input by a user, such as clicking or double-clicking a shared object, selecting an option for opening the shared object, and so on. The user inputs a display instruction for the shared object, and then calls a relevant program to open the shared object in a second display area to exhibit the content of the shared object. For example, for a document file, an office program is called to open the office document in the second display area; for an image, an image editing program such as painting is called to open the image in the second display area; for a game, a game program is called to open the game in the second display area.

In an implementation of step S12, user A operates the displayed office document in a second display area of a session window; and an IM client on a first terminal receives the operation by user A.

In one embodiment of step S13, the first terminal sends the operation to a network device; receives, and presents or stores a processing result of the shared object by the network device according to the operation, and the processing result is synchronized to the second terminal by the network device.

An IM client on the first terminal sends the received operation of user A to a sharing server. The sharing server processes the office document stored in the sharing server according to the operation, and determines and saves change of the office document. Meanwhile, the sharing server simultaneously sends the change of the office document to the first terminal and the second terminal which are running a video call.

In one embodiment, an IM client on a first terminal also sends a user ID of user A to the sharing server while sending the operation to the sharing server. The sharing server determines change of the office document according to the operation, saves the change of the office document and the corresponding user ID in the office document, and sends the change of the office document and the corresponding user ID to the first terminal and a second terminal which are running a video call, and the user A and the user B who are in the video call can view a processing result of the office document resulting from the operation by user A. User A and user B may operate the office document while being in a video call and exchanging views. A processing result of this operation may be viewed by user A and user B synchronously, and a document generated by team collaboration is obtained.

The IM clients on the first terminal and the second terminal receive the change of the office document sent by the sharing server, and present the change in the second display area.

In one embodiment, the change may be presentable or hidden. If it is presentable, then it is displayed in the second display area directly. If it is hidden, it is only recorded in background but not displayed in the second display area.

In one embodiment, since the shared object is stored in a sharing server, it may be determined whether the shared object is operable by users at separate times or at the same time according to the property of the shared object. If it is determined that the shared object is operable by users at separate times, the shared object or a unit in the shared object can only be operated by one user at a time. If it is determined that the shared object is operable by users at the same time, the shared object can be operated by multiple users at a time. For a shared object which is determined to be operable by users at separate times, when a first terminal detects that a user has started operating the shared object or a unit in the shared object, the first terminal sends a first notification message that the user is operating the shared object or the unit in the shared object. The first notification message may be received by a sharing server or other servers, to be forwarded to a second terminal. In some embodiments, the first notification message may also be sent to the second terminal directly. After the first notification message is received, the second terminal may present prompt information to the user, to indicate to the user who is using the second terminal that the user who is using the first terminal is operating the shared object or the unit in the shared object. In some embodiments, the second terminal may present the prompt information to the user of the second terminal after detecting that the user has started operating the shared object or the unit in the shared object. For a shared object which is determined to be operable by users at separate times, the second terminal may employ various methods to determine whether the operation on the shared object by a user of the first terminal is completed. In some embodiments, after detecting that the operation on the shared object by the user is completed, the first terminal sends a second notification message to the sharing server or other servers. The sharing server or other servers forward the second notification message to the second terminal to notify the second terminal that the operation on the shared object by the user of the first terminal is completed. After receiving the second notification message, the second terminal determines that the operation on the shared object by the user of the first terminal is completed, which means the user of the second terminal may operate the shared object. In some embodiments, the first terminal does not send the second notification message, and the second terminal may determine that the operation on the shared object by the user of the first terminal is completed by receiving the operation on the shared object by the user of the first terminal.

For example, the office document can only be operated by one user at a time. Alternatively, the same paragraph or area can only be operated by one user at a time, i.e., the shared object is operable by users at separate times.

In one embodiment, when user A on a first terminal operates an office document and clicks a save button, an IM client on the first terminal sends the operation performed by user A before user A clicking the save button to a sharing server. Before sending the operation performed by the user before the user clicking the save button to the sharing server, the IM client on the first terminal will send to the sharing server, a first notification message that user A is operating the document, after detecting that user A has started an editing operation. The sharing server forwards the first notification message to user B, to prompt user B to suspend operating the shared object until user A completes his/her operation.

In one embodiment, paragraphs or areas in the office document that may be edited by different users respectively may be configured, and different users edit different paragraphs or areas at the same time to improve collaboration efficiency. Before sending the operation performed by the user before the user clicking the save button to the sharing server, an IM client on the first terminal will send to the sharing server, a first notification message that user A is operating the document, after detecting that user A has started an editing operation. The sharing server sends the first notification message to user B. The notification message comprises the paragraph(s) or area(s) that is being edited by user A.

Rather, an image may be operated by multiple users at the same time. An IM client on a first terminal may send the operation by user A to the sharing server. The sharing server processes the image stored in the sharing server according to the operation, and determines and saves change of the image. Meanwhile, the sharing server simultaneously sends the change of the image to user B on a second terminal which is running a video call.

FIG. 2 is a schematic diagram of a process implemented at a network device provided in Embodiment one of the present application. As shown in FIG. 2, the process comprises the following steps:

step S21, the network device receives an operation on the shared object by a user of a first terminal that is sent by the first terminal which has established a video call with a second terminal; and the first terminal and the second terminal simultaneously display the shared object and a video of an opposite terminal;

step S22, the shared object is processed according to the operation; and a processing result is simultaneously sent to the first terminal and the second terminal, and the first terminal and the second terminal synchronously present or store the processing result of the shared object obtained according to the operation.

The method shown in FIG. 2 may be performed by a network device.

In one embodiment of step S21, the sharing server receives an operation on the shared object by a user of the first terminal that is sent by the first terminal which has established a video call with the second terminal.

User A successfully logs in an IM client on the first terminal, and then establishes a video call with user B who successfully logs in an IM client on the second terminal through an instant messaging server, and a shared object is displayed. The session window is divided into at least two display areas, in which a first display area is a session interface and a second display area is a shared object display interface. The shared object such as an office document is displayed on the shared object display interface. The office document is displayed in a second display area of a session window of user A. Meanwhile, the office document is displayed in a second display area of a session window of user B. The office documents displayed in the session windows of user A and user B are the same.

The office document is a network document on a sharing server. In one embodiment, when a shared object with user B is determined, user A sends a request to share objects with user B to the sharing server, and the request is forwarded by the sharing server to user B. When user B accepts the request, the shared object is automatically opened in the second terminal without requiring other operation from user B.

User A operates the office document in the second display area of his/her session window.

In a specific implementation, the shared object includes but is not limited to: a document file, an image, a game, and so on. In one embodiment, the display instruction may include, but is not limited to: a file opening instruction input by a user, such as clicking or double-clicking a targeted shared object, selecting an option for opening the targeted shared object, and so on. The user inputs a display instruction for the targeted shared object, and then the targeted shared object is opened in a second display area and the content of the targeted shared object is exhibited.

In one embodiment, the sharing server also receives a user ID of user A while receiving the operation sent by an IM client on the first terminal.

In one embodiment of step S22, the sharing server processes the office document stored in the sharing server according to the operation on the shared object by a user of the first terminal that is sent by the first terminal which has established a video call with the second terminal, and determines and saves change of the office document. Meanwhile, the sharing server simultaneously sends the change of the office document to user B on the second terminal which is running the video call, and the first terminal and the second terminal synchronously present or store a processing result of the office document obtained according to the operation.

In one embodiment, the sharing server also receives a user ID of user A while receiving the operation sent by the IM client on a first terminal. The sharing server determines change of the office document according to the operation, saves the change of the office document and the corresponding user ID in the office document, and sends the change of the office document and the corresponding user ID to user A of the first terminal and user B of a second terminal who are in a video call, and user A and user B who are in the video call can view a processing result the office document resulting from the operation by user A.

The IM clients on the first terminal and the second terminal receive the change of the office document sent by the sharing server, and present the change in the second display area.

In one embodiment, the change may be presentable or hidden. If it is presentable, then it is displayed in the second display area directly. If it is hidden, it is only recorded in background but not displayed in the second display area.

In one embodiment, since the shared object is stored in a sharing server, it is determined whether the shared object is operable by users at separate times or at the same time according to the property of the shared object. The details of the shared object being operable by users at separate times or at the same time have been described in the foregoing, and thus will not be described herein again.

FIG. 3 is a schematic diagram of a process implemented at a second terminal provided in Embodiment one of the present application. As shown in FIG. 3, the process comprises the following steps:

step S31, a second terminal establishes a video call with a first terminal, and displays a shared object and a video of an opposite terminal; and

step S32, receives and presents a processing result of the shared object obtained by a network device according to an operation on the shared object by a user of the first terminal.

The method shown in FIG. 3 may be performed by a second terminal installed with instant messaging software.

In one embodiment of step S31, user B successfully logs in an IM client on the second terminal, and then establishes a video call with user A who successfully logs in an IM client on the first terminal through an instant messaging server. The shared object and a video of an opposite terminal are displayed.

The shared object may be determined before, at the same time when, or after the video call is established. The shared object such as an office document is a network document on a sharing server. In one embodiment, the office document is a document uploaded to the sharing server in advance. Alternatively, the office document is a document selected by user A and then uploaded to the sharing server.

In one embodiment, the second terminal receives a link or identification information of a shared object with a user of a second terminal in a sharing server that is sent by the first terminal and displays the shared object. When user B clicks the link of the shared object sent by user A, the shared object will be opened in the second terminal, or user B obtains the shared object from the sharing server according to the identification information of the shared object sent by user A, and opens the shared object in the second terminal. User B receives a request that user A wishes to share an object with user B that is forwarded by a server, and accepts the request. The shared object is automatically opened in the second terminal without requiring other operation from user B. The session window is divided into at least two display areas, in which a first display area is a session interface and a second display area is a shared object display interface. The office document is displayed on the shared object display interface.

A video of user A is displayed in a first display area of a session window of user B. Meanwhile, a video of user B is displayed in a first display area in a session window of user A.

In one embodiment, while the video of user A is displayed in the first display area of the session window of user B, a third display area may be set up for displaying a local video of user B. The third display area may be displayed in parallel with the first display area, or may be displayed in a picture in picture mode. No specific limitation is made herein.

The office document is displayed in a second display area of a session window of user B. Meanwhile, the office document is displayed in a second display area of a session window of user A. The office documents displayed in the session windows of user B and user A are the same.

In a specific implementation, the shared object includes but is not limited to: a document file, an image, and a game operable by each of the users in a video call, and so on. In one embodiment, the display instruction may include, but is not limited to: a file opening instruction input by a user, such as clicking or double-clicking a targeted shared object, selecting an option for opening the targeted shared object, and so on. The user inputs a display instruction for the targeted shared object, and then calls a relevant program to open the targeted shared object in a second display area to exhibit the content of the targeted shared object. For example, for a document file, an office program is called to open the office document in the second display area; for an image, an image editing program such as painting is called to open the image in the second display area; for a game, a game program is called to open the game in the second display area.

In one embodiment of step S32, an IM client on the second terminal receives and presents the processing result of the office document obtained by the sharing server according to the operation on the shared object by a user of the first terminal.

The sharing server processes the office document stored in the sharing server according to the operation sent by the first terminal, and determines and saves change of the office document. Meanwhile, the sharing server simultaneously sends the change of the office document to the IM client on the second terminal which is running a video call.

In one embodiment, the sharing server also receives a user ID of user A while receiving the operation sent by the IM client on the first terminal. The sharing server determines change of the office document according to the operation, saves the change of the office document and the corresponding user ID in the office document, and sends the change of the office document and the corresponding user ID to user A on the first terminal and user B on a second terminal who are in a video call, and user A and user B who are in the video call can view a processing result of the office document resulting from the operation by user A.

The IM clients on the first terminal and the second terminal receive the change of the office document sent by the sharing server, and present the change in the second display area.

In one embodiment, the change may be presentable or hidden. If it is presentable, then it is displayed in the second display area directly. If it is hidden, it is only recorded in background but not displayed in the second display area.

In one embodiment, since the shared object is stored in a sharing server, it may be determined whether the shared object is operable by users at separate times or at the same time according to the property of the shared object. The details of the shared object being operable by users at separate times or at the same time have been described in the foregoing, and thus will not be described herein again.

### Embodiment Two

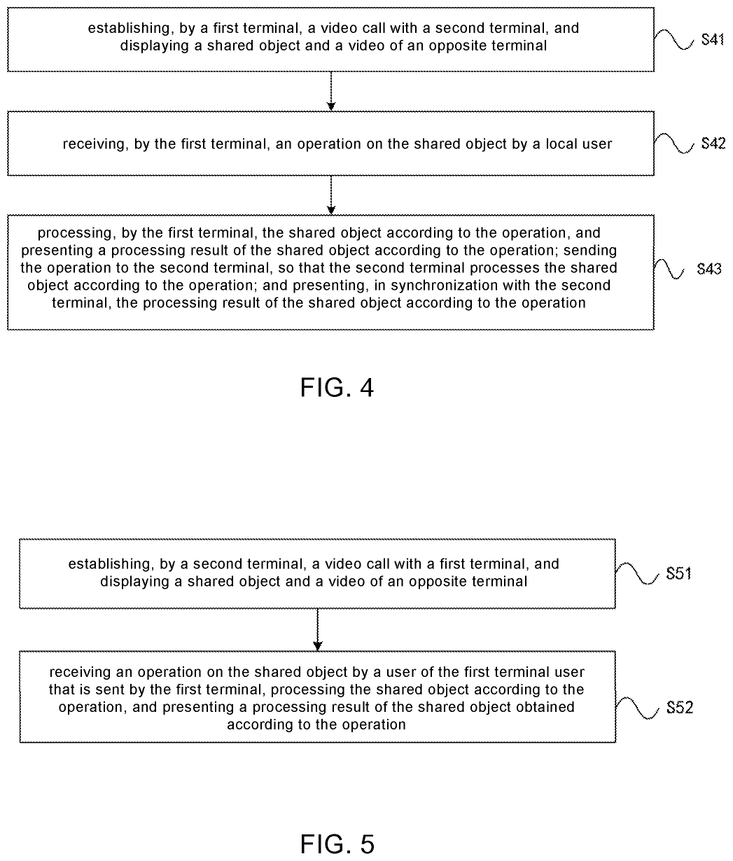

FIG. 4 is a schematic diagram of a process implemented at a first terminal provided in Embodiment Two of the present application. As shown in FIG. 4, the process comprises the following steps:

step S41, the first terminal establishes a video call with a second terminal, and displays a shared object and a video of an opposite terminal;

step S42, the first terminal receives an operation on the shared object by a local user; and

step S43, the first terminal processes the shared object according to the operation; sends the operation to the second terminal, and the second terminal processes the shared object according to the operation; and presents, in synchronization with the second terminal, a processing result of the shared object according to the operation.

The method shown in FIG. 4 may be performed by a first terminal installed with instant messaging software.

The terminal includes but is not limited to any type of smart terminal device for human-machine interaction with users, such as a smart phone, a tablet, a laptop, etc. The smart terminal device may adopt any operating system, such as android operating system, iOS operating system, Windows operating system, etc.

It should be noted that the method of operating the shared object in the video call described in some embodiments of the present disclosure is mainly applied in a scenario where a user conducts instant messaging with a mobile terminal.

In one embodiment, multiple users using mobile terminals for instant messaging may be two or more users. The multiple users may make a group video call. Since operations performed by the multiple users are similar, user A on a first terminal and user B on a second terminal are taken as examples for illustration in this embodiment. User A on the first terminal operates the shared object, and the second terminal may synchronously present or store a processing result of the shared object determined based on the operation on the shared object by user A. The above example in this embodiment is merely for illustration, but not for limitation. In some embodiments, the mobile terminal used by each of the multiple users who use the mobile terminals for instant messaging can not only be used by the user to operate the displayed shared object, and display or store a processing result of the shared object, but also synchronously present or store the processing result determined according to the operation on the shared object by another user who is in instant messaging with the user who is using the mobile terminal. In some embodiments, the processing result is presentable, and the first terminal and the second terminal may present the processing result synchronously. In some embodiments, the processing result is hidden (for example, unpresentable), and the first terminal and the second terminal may store the processing result synchronously.

In one embodiment of step S41, In one embodiment, user A successfully logs in an IM client on the first terminal, and then establishes an instant session with user B who successfully logs in an IM client on the second terminal through an instant messaging server. User A determines a shared object with user B. For example, user A clicks a menu in an instant session window, and further clicks a submenu for sharing objects, and selects a shared object with user B in a pop-up window through a display instruction, for example, an office document. The office document is sent to the second terminal where user B is located, and is received and stored. Then the first terminal and the second terminal simultaneously store the same version of the office document. After the office document has been displayed in the second display areas of the first terminal and the second terminal, then user A may initiate a video call by clicking a video call button on his/her session window.

In one embodiment, user A successfully logs in an IM client on the first terminal, and then establishes an instant session with user B who successfully logs in an IM client on the second terminal through an instant messaging server. User A determines a shared object with user B and initiates a video call. For example, user A clicks a menu in an instant session window, and further clicks a submenu for sharing objects, selects a shared object with user B in a pop-up window through a display instruction, for example, an office document, and simultaneously, initiates a video call with user B. The office document is sent to the second terminal where user B is located. Then the first terminal and the second terminal simultaneously store the same version of the office document.

In one embodiment, user A successfully logs in an IM client on the first terminal, and then establishes a video session with user B who successfully logs in an IM client on the second terminal through an instant messaging server. User A determines a shared object with user B. For example, user A clicks a menu in a session window, and further clicks a submenu for sharing objects, and selects a shared object with user B in a pop-up window through a display instruction, for example, an office document. The office document is sent to the second terminal where user B is located. Then the first terminal and the second terminal simultaneously store the same version of the office document.

The session window is divided into at least two display areas, in which a first display area is a session interface and a second display area is a shared object display interface. The shared object such as an office document is displayed on the shared object display interface.

A video of user B is displayed in a first display area of a session window of user A. Meanwhile, a video of user A is displayed in a first display area in a session window of user B. The video call may also be initiated by user B through clicking a video call button on his/her session window. A video of user A is displayed in a first display area of session window of user B. Meanwhile, a video of user B is displayed in a first display area in a session window of user A.

In one embodiment, while a video of an opposite terminal is displayed in a first display area of a session window, a third display area may be set up for displaying a local video. The third display area may be displayed in parallel with the first display area, or may be displayed in a picture in picture mode.

The office document is displayed in a second display area of a session window of user A. Meanwhile, the office document is displayed in a second display area of a session window of user B. The office documents displayed in the session windows of user A and user B are the same.

In some embodiments, the shared object includes but is not limited to: a document file, an image, a game, and so on. The display instruction may include, but is not limited to: a file opening instruction input by a user, such as clicking or double-clicking a targeted shared object, selecting an option for opening the targeted shared object, and so on. The user inputs a display instruction for the targeted shared object, and then calls a relevant program to open the targeted shared object in a second display area to exhibit the content of the targeted shared object. For example, for a document file, an office program is called to open the office document in the second display area; for an image, an image editing program such as painting is called to open the image in the second display area; for a game, a game program is called to open the game in the second display area.

In one embodiment, the session may be a group call established by users who log in IM clients on multiple terminals. The multiple users may make a group video call. Multiple display areas may be set in a session window for displaying a local video and a video of an opposite terminal. The multiple display areas may be displayed in parallel, or may be displayed in a picture in picture mode, or may be adjusted according to user settings. In this embodiment, user A on the first terminal and user B on the second terminal are taken as an example.

In one embodiment of step S42, user A operates the displayed office document in a second display area of a session window; and an IM client on a first terminal receives the operation by user A.

In one embodiment of step S43, an IM client on the first terminal determines change of the office document according to the operation by user A, and displays a processing result in a second display area. The change may be visible or hidden. If it is visible, then it is directly displayed in the second display area in real time. If it is hidden, it is only recorded in background but not displayed in the second display area.

An IM client on the first terminal sends the operation by user A to an IM client on the second terminal. In one embodiment, the operation may be sent to the IM client on the second terminal through a point to point direct device connection (P2P) or through relay of a network device. The IM client on the second terminal receives the operation by user A, processes the office document stored on the second terminal, and displays a processing result in a second display area.

The first terminal and the second terminal synchronously present the processing result of the office document according to the operation.

In one embodiment, an IM client on the first terminal also sends a user ID of user A while sending the operation to an IM client on the second terminal. The IM client on the second terminal determines change of the office document according to the operation, saves the change of the office document and the corresponding user ID in the office document, and presents the change of the office document and the corresponding user ID to user B in the second display area, and user A and user B who are in the video call can view a processing result of the office document resulting from the operation by user A.

In one embodiment, the change may be presentable or hidden. If it is presentable, then it is displayed in the second display area directly. If it is hidden, it is only recorded in background but not displayed in the second display area.

In one embodiment, it may be determined whether the shared object is operable by users at separate times or at the same time according to the property of the shared object.

For example, the office document or the same paragraph or area in the document can only be operated by one user at a time, i.e., the shared object is operable by users at separate times.

In one embodiment, when user A on a first terminal operates an office document and clicks a save button, an IM client on the first terminal sends the operation performed by user A before user A clicking the save button to an IM client on the second terminal. The IM client on the first terminal receives the operation on the office document by user A. Before sending the operation performed by the user before the user clicking the save button to the IM client on the second terminal, the IM client on the first terminal will send to the IM client on the second terminal, a first notification message that user A is operating the document, to prompt user B to suspend operating the shared object until user A completes his/her operation.

In one embodiment, paragraphs or areas in the office document that may be edited by different users respectively may be configured, and different users edit different paragraphs or areas at the same time to improve collaboration efficiency. An IM client on the first terminal receives the operation on the office document by user A. Before sending the operation performed by the user before the user clicking the save button to the IM client on the second terminal, the IM client on the first terminal will send to the IM client on the second terminal, a first notification message that user A is operating the document. The first notification message comprises the paragraph(s) or area(s) which is being edited by user A.

Rather, an image may be operated by multiple users at the same time. An IM client on a first terminal may send the operation by user A to an IM client on a second terminal. The IM client on the second terminal processes the image stored in the second terminal according to the operation, and determines and presents change of the image.

In this Embodiment Two, the network device is an instant messaging server, which actually implements functions of establishing instant messaging and functions of forwarding the operations sent by users.

FIG. 5 is a schematic diagram of a process implemented at a second terminal provided in Embodiment Two of the present application. As shown in FIG. 5, the process comprises the following steps:

step S51, a second terminal establishes a video call with a first terminal, and displays a shared object and a video of an opposite terminal; and

step S52, an operation on the shared object by a user of the first terminal that is sent by the first terminal is received, the shared object is processed according to the operation, and a processing result of the shared object obtained according to the operation is presented.

The method shown in FIG. 5 may be performed by a second terminal installed with instant messaging software.

In one embodiment of step S51, user B successfully logs in an IM client on the second terminal, and then establishes a video call with user A who successfully logs in an IM client on the first terminal through an instant messaging server. The shared object and a video of user A are displayed. The shared object may be determined before, at the same time when, or after the video call is established. The shared object such as an office document is sent to the second terminal where user B is located, and is received and stored. Then the first terminal and the second terminal simultaneously store the same version of the office document.

The session window is divided into at least two display areas, in which a first display area is a session interface and a second display area is a shared object display interface. The office document is displayed on the shared object display interface.

A video of user A is displayed in a first display area of a session window of user B. Meanwhile, a video of user B is displayed in a first display area in a session window of user A.

In one embodiment, while the video of user A is displayed in the first display area of the session window of user B, a third display area may be set up for displaying a local video of user B. The third display area may be displayed in parallel with the first display area, or may be displayed in a picture-in-picture mode. No specific limitation is made herein.

The office document is displayed in a second display area of a session window of user B. Meanwhile, the office document is displayed in a second display area of a session window of user A. The office documents displayed in the session windows of user B and user A are the same.

In some embodiments, the shared object includes but is not limited to: a document file, an image, a game, and so on. In one embodiment, the display instruction may be a file opening instruction input by a user, such as clicking or double-clicking a targeted shared object, selecting an option for opening the targeted shared object, and so on. The user inputs a display instruction for the targeted shared object, and then calls a relevant program to open the targeted shared object in a second display area to exhibit the content of the targeted shared object. For example, for a document file, an office program is called to open the office document in the second display area; for an image, an image editing program such as painting is called to open the image in the second display area; for a game, a game program is called to open the game in the second display area.

In one embodiment of step S52, an IM client on the second terminal receives the operation by user A that is sent by an IM client on the first terminal. In one embodiment, the operation may be received through a point to point direct device connection (P2P) or through relay of a network device. The IM client on the second terminal receives the operation by user A, processes the office document stored on the second terminal, and displays a processing result in a second display area.

In one embodiment, an IM client on the second terminal also receives a user ID of user A sent by an IM client on the first terminal while receiving the operation. The IM client on the second terminal determines change of the office document according to the operation, saves the change of the office document and the corresponding user ID in the office document, and presents the change of the office document and the corresponding user ID to user B in the second display area, and user A and user B who are in the video call can view a processing result of the office document resulting from the operation by user A. While user A is operating the office document, user A and user B may conduct a video call and share viewpoints, and a document generated by team collaboration is obtained.

In one embodiment, the change may be presentable or hidden. If it is presentable, then it is displayed in the second display area directly. If it is hidden, it is only recorded in background but not displayed in the second display area.

In one embodiment, it may be determined whether the shared object is operable by users at separate times or at the same time according to the property of the shared object. The details of the shared object being operable by users at separate times or at the same time have been described in the foregoing, and thus will not be described herein again.

For example, the office document can only be operated by one user at a time, i.e., the office document is operable by users at separate times.

In one embodiment, when user A on a first terminal operates an office document and clicks a save button, an IM client on the first terminal sends an operation performed by user A before user A clicking the save button to an IM client on the second terminal. The IM client on the second terminal receives the operation. The IM client on the first terminal receives the operation on the office document by user A. Before sending the operation performed by the user before the user clicking the save button to the IM client on the second terminal, the IM client on the first terminal will send to the IM client on the second terminal, a notification message that user A is operating the document. The IM client on the second terminal receives the first notification message that user A is operating the document, to prompt user B to suspend operating the shared object until user A completes his/her operation.

In one embodiment, paragraphs or areas in the office document that may be edited by different users respectively may be configured, and different users edit different paragraphs or areas at the same time to improve collaboration efficiency. An IM client on the first terminal receives the operation on the office document by user A. Before sending the operation performed by the user before the user clicking the save button to the IM client on the second terminal, the IM client on the first terminal will send to the IM client on the second terminal a first notification message that user A is operating the document. The IM client on the second terminal receives the first notification message that user A is operating the document. The first notification message comprises the paragraph(s) or area(s) which is being edited by user A.

Rather, an image may be operated by multiple users at the same time. An IM client on a first terminal may send the operation by user A to an IM client on a second terminal. The IM client on the second terminal receives the operation, processes the image stored in the second terminal according to the operation, and determines and presents change of the image.

In this embodiment, a user of a video session may operate a shared object while being in a video call and a processing result is presented synchronously. This improves collaboration efficiency of users.

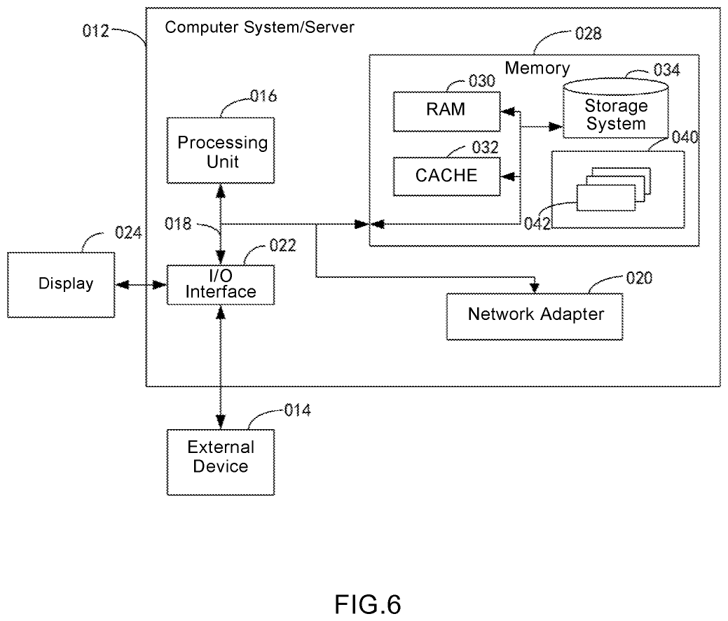

FIG. 6 shows a block diagram of an exemplary computer system/server 012 suitable for implementing the embodiments of the present disclosure. The computer system/server 012 shown in FIG. 6 is merely an example, and should not impose any limitation on the functions and scope of use of the embodiments of the present disclosure.

As shown in FIG. 6, the computer system/server 012 is embodied as a general-purpose computing device. Components of the computer system/server 012 may include but are not limited to one or more processors or processing units 016, a system memory 028, a bus 018 connecting different system components (including the system memory 028 and the processing unit 016).

The bus 018 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 012 typically includes a variety of computer system readable media. These media can be any available media that can be accessed by the computer system/server 012, including volatile and non-volatile media, removable and non-removable media.

The system memory 028 may include computer system readable media in the form of a volatile memory, such as a random access memory (RAM) 030 and/or a cache memory 032. Computer system/server 012 may further include other removable/non-removable, volatile/nonvolatile computer system storage media. By way of example only, the storage system 034 may be used to read and write non-removable, non-volatile magnetic media (not shown in FIG. 6 and is commonly referred to as a “hard drive”). Although not shown in FIG. 6, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 018 through one or more data media interfaces. The memory 028 may include at least one program product having a set of (e.g., at least one) program modules configured to perform the functions of the embodiments of the present disclosure.

A program/utility tool 040 having a set of (at least one) program modules 042 may be stored in, for example, the memory 028. Such program modules 042 include, but are not limited to, an operating system, one or more application programs, other programs modules and program data, each or some combination of these examples may include implementations of the network environment. The program module 042 generally performs functions and/or methods in the embodiments described in the present disclosure.

The computer system/server 012 can also communicate with one or more external devices 014 (e.g., a keyboard, a pointing device, a display 024, etc.). In the present disclosure, the computer system/server 012 can communicate with external radar devices, and can also communicate with one or more devices that enable users to interact with the computer system/server 012, and/or with any device (such as a network card, a modem, etc.) that enables the computer system/server 012 to communicate with one or more other computing devices. Such communication can be performed through an input/output (I/O) interface 022. Moreover, the computer system/server 012 can also communicate with one or more networks (such as a local area network (LAN), a wide area network (WAN), and/or a public network, such as the Internet) through a network adapter 020. As shown in FIG. 6, the network adapter 020 communicates with other modules of the computer system/server 012 through the bus 018. It should be understood that although not shown in FIG. 6, other hardware and/or software modules may be used in conjunction with the computer system/server 012, including but not limited to: microcode, device drivers, redundant processing units, external disk drive arrays, RAID systems, tape drives and data backup storage systems.

The processing unit 016 executes programs stored in the system memory 028 to execute the functions and/or methods in the embodiments described in the present disclosure.

The above-mentioned computer programs may be set in computer storage media, that is, the computer storage media are encoded with computer programs, which when executed by one or more computers, causes the one or more computers to execute the method flows and/or apparatus operations shown in the above-described embodiments of the present disclosure.

With the development of time and technology, the meaning of media has become more and more extensive. The propagation method of computer programs is no longer limited to tangible media. Computer programs can also be downloaded directly from the network. Any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus, or device.

Program code embodied on computer-readable media may be transmitted using any appropriate media, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

1. A method of operating a shared object in a video call, comprising:
establishing, by a first terminal, the video call with a second terminal, and displaying the shared object and a video of an opposite terminal, wherein the opposite terminal of the first terminal is the second terminal;
receiving an operation on the shared object by a user of the first terminal; and
presenting or storing, in synchronization with the second terminal, a processing result of the shared object according to the operation.

2. The method of claim 1, wherein the shared object comprises a document, an image, or a game.

3. The method of claim 1, wherein the step of presenting or storing, in synchronization with the second terminal, the processing result of the shared object according to the operation comprising:
sending the operation to a network device; and
receiving, and presenting or storing the processing result of the shared object by the network device according to the operation, wherein the processing result is synchronized to the second terminal by the network device.

4. The method of claim 3, wherein before the step of displaying the shared object, the method further comprising:
determining, by the first terminal, the shared object, and sending information on the shared object to the network device and the second terminal.

5. The method of claim 1, wherein the step of presenting or storing, in synchronization with the second terminal, the processing result of the shared object according to the operation comprising:
processing the shared object according to the operation, and presenting or storing the processing result of the shared object according to the operation; and
sending the operation to the second terminal, wherein the second terminal processes the shared object according to the operation, and presents or stores the processing result of the shared object according to the operation.

6. The method of claim 5, wherein before the step of displaying the shared object, the method further comprising:
determining, by the first terminal, the shared object, and sending information on the shared object to the second terminal.

7. The method of claim 4, wherein the information on the shared object which is sent to the second terminal comprises:
a file of the shared object, a link of the shared object, or identification information of the shared object.

8. The method of claim 1, wherein the method further comprising:
displaying the video of the opposite terminal in a first display area in a video call interface, and displaying the shared object in a second display area in the video call interface.

9. The method of claim 8, wherein the method further comprising:
setting a third display area in a current call interface, and displaying a local video in the third display area.

10. A method of operating a shared object in a video call, comprising:
receiving an operation on the shared object by a user of a first terminal that is sent by the first terminal which has established a video call with a second terminal, wherein the first terminal and the second terminal simultaneously display the shared object and a video of an opposite terminal, wherein the opposite terminal of the first terminal is the second terminal and the opposite terminal of the second terminal is the first terminal;
processing the shared object according to the operation; and
simultaneously sending a processing result to the first terminal and the second terminal, wherein the first terminal and the second terminal synchronously present or store the processing result of the shared object obtained according to the operation.

11. The method of claim 10, wherein the processing result comprises change of the shared object determined according to the operation.

12. A method of operating a shared object in a video call, comprising:
establishing, by a second terminal, the video call with a first terminal, and displaying the shared object and a video of an opposite terminal, wherein the opposite terminal of the second terminal is the first terminal; and
presenting or storing a processing result of the shared object obtained according to an operation on the shared object by a user of the first terminal.

13. The method of claim 12, wherein the shared object comprises a document, a picture, and a game operable by each of the users in the video call.

14. The method of claim 12, wherein the step of presenting or storing the processing result of the shared object obtained according to the operation on the shared object by the user of the first terminal comprising:
receiving, and presenting or storing the processing result of the shared object by a network device according to the operation.

15. The method of claim 14, wherein before the step of displaying the shared object, the method further comprising:
receiving information on the shared object which is determined by the first terminal and sent by the first terminal, wherein the information is sent to the network device simultaneously.

16. The method of claim 12, wherein the step of presenting or storing the processing result of the shared object obtained according to the operation on the shared object by the user of the first terminal comprising:
receiving the operation on the shared object by the user of the first terminal user which is sent by the first terminal;
processing the shared object according to the operation; and
presenting or storing the processing result of the shared object obtained according to the operation.

17. The method of claim 16, wherein before the step of displaying the shared object, the method further comprising:
receiving information on the object to be shared which is determined by the first terminal and sent by the first terminal.

18. The method of claim 15, wherein the information on the shared object determined by the first terminal comprises:
a file of the shared object, a link of the shared object, or identification information of the shared object.

19. The method of claim 12, wherein the method further comprising:
displaying the video of the opposite terminal in a first display area of a video call interface, and displaying the shared object in a second display area of the video call interface.

20. The method of claim 19, wherein the method further comprising:
setting a third display area in a current call interface, and displaying a local video in the third display area.
